(19) United States
(12) Patent Application Publication
(10) Pub. No.: US 2025/0307915 A1
(43) Pub. Date: Oct. 2, 2025

(54) DATA PROCESSING METHOD, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Wei LIU, Shenzhen (CN)

(21) Appl. No.: 19/234,187

(22) Filed: Jun. 10, 2025

Related U.S. Application Data
(63) Continuation of application No. PCT/CN2023/130357, filed on Nov. 8, 2023.

(30) Foreign Application Priority Data
May 22, 2023 (CN) 202310582399.8

(51) Int. Cl. G06Q 40/02; G06Q 20/38

(52) U.S. Cl. CPC G06Q 40/02; G06Q 20/3829; G06Q 2220/00

(57) ABSTRACT

A data processing method includes receiving, through a target domain transaction component in at least one domain transaction component of an electronic device, a transaction task in a target domain corresponding to the target domain transaction component, and executing the transaction task, to obtain a transaction execution result; transmitting, through the target domain transaction component, the transaction execution result to a micro-core component of the electronic device; determining, through the micro-core component, a resource type associated with the transaction execution result; and determining, through the micro-core component based on the transaction execution result and the resource type associated with the transaction execution result, a transfer relationship between account numbers associated with the transaction task, and performing transfer accounting processing on resources of the account numbers based on the transfer relationship.

### CROSS-REFERENCES TO RELATED APPLICATIONS

The present disclosure is a continuation application of PCT Patent Application No. PCT/CN2023/130357, filed on Nov. 8, 2023, which claims priority to Chinese Patent Application No. 202310582399.8, filed on May 22, 2023, all of which is incorporated herein by reference in their entirety.

### FIELD OF THE TECHNOLOGY

The present disclosure relates to the field of computer technologies, and in particular, to a data processing method and apparatus, an electronic device, a computer-readable storage medium, and a computer program product.

### BACKGROUND OF THE DISCLOSURE

Resources used in an online domain transaction scenario mainly include a digital resource and a balance resource. The balance resource refers to a resource used as a general equivalent during a transaction. The digital resource refers to a virtual resource based on a node network and a digital encryption algorithm.

An accounting method of digital resources, especially a decentralized encrypted resource, primarily relies on a blockchain technology. However, blockchain-based transaction methods suffer from performance limitations, making them unsuitable for more complex domain transaction scenarios associated with balance resources, such as wealth management and insurance. In addition, the accounting system for the balance resource relies on large-scale databases, and an accounting process is tightly coupled with the domain transaction scenario involved with the balance resource. Therefore, the accounting system for the balance resource is more complex to implement in terms of scalability. For example, an accounting system suitable for wealth management scenario is difficult to be used in insurance scenarios. In addition, transaction processes for the balance resource and the digital resource differ significantly, making it difficult to directly use the accounting system of the balance resource for the digital resource.

### SUMMARY

An embodiment of the present disclosure provides a data processing method performed by an electronic device that includes at least one domain transaction component and a micro-core component. The method includes: receiving, through a target domain transaction component in the at least one domain transaction component, a transaction task in a target domain corresponding to the target domain transaction component, and executing the transaction task, to obtain a transaction execution result; transmitting, through the target domain transaction component, the transaction execution result to the micro-core component; determining, through the micro-core component, a resource type associated with the transaction execution result; and determining, through the micro-core component based on the transaction execution result and the resource type associated with the transaction execution result, a transfer relationship between account numbers associated with the transaction task, and performing transfer accounting processing on resources of the account numbers based on the transfer relationship.

Another embodiment of the present disclosure provides an electronic device. The electronic device includes one or more processors and a memory containing computer-executable instructions that, when being executed, cause the one or more processors to perform: receiving, through a target domain transaction component in at least one domain transaction component of the electronic device, a transaction task in a target domain corresponding to the target domain transaction component, and executing the transaction task, to obtain a transaction execution result; transmitting, through the target domain transaction component, the transaction execution result to a micro-core component of the electronic device; determining, through the micro-core component, a resource type associated with the transaction execution result; and determining, through the micro-core component based on the transaction execution result and the resource type associated with the transaction execution result, a transfer relationship between account numbers associated with the transaction task, and performing transfer accounting processing on resources of the account numbers based on the transfer relationship.

Another embodiment of the present disclosure provides a non-transitory computer-readable storage medium containing computer-executable instructions that, when being executed, cause at least one processor of an electronic device to perform: receiving, through a target domain transaction component in at least one domain transaction component of the electronic device, a transaction task in a target domain corresponding to the target domain transaction component, and executing the transaction task, to obtain a transaction execution result; transmitting, through the target domain transaction component, the transaction execution result to a micro-core component of the electronic device; determining, through the micro-core component, a resource type associated with the transaction execution result; and determining, through the micro-core component based on the transaction execution result and the resource type associated with the transaction execution result, a transfer relationship between account numbers associated with the transaction task, and performing transfer accounting processing on resources of the account numbers based on the transfer relationship.

### BRIEF DESCRIPTION OF THE DRAWINGS

FIG. 1 is a schematic diagram of a network architecture according to an embodiment of the present disclosure.

FIG. 2 is a schematic diagram of a scenario of resource transfer and accounting according to an embodiment of the present disclosure.

FIG. 3 is a schematic flowchart of a data processing method according to an embodiment of the present disclosure.

FIG. 4 is a schematic diagram of a double-entry accounting process according to an embodiment of the present disclosure.

FIG. 5 is a schematic diagram of a digital resource transfer process according to an embodiment of the present disclosure.

FIG. 6 is a schematic flowchart of a data processing method according to an embodiment of the present disclosure.

FIG. 7 is a schematic diagram of a product of an accounting system according to an embodiment of the present disclosure.

FIG. 8 is a schematic architectural diagram of an accounting system according to an embodiment of the present disclosure.

FIG. 9a is a schematic diagram of an operation model of a first account number according to an embodiment of the present disclosure.

FIG. 9b is a schematic diagram of an operation model of a second account number according to an embodiment of the present disclosure.

FIG. 10 is a schematic structural diagram of a data processing apparatus according to an embodiment of the present disclosure.

FIG. 11 is a schematic structural diagram of an electronic device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

The present disclosure discloses a data processing method and apparatus, an electronic device, a computer-readable storage medium, and a computer program product. The method includes: receiving, through a target domain transaction component among at least one domain transaction component, a transaction task in a target field corresponding to the target domain transaction component, and executing the transaction task, to obtain a transaction execution result; transmitting the transaction execution result to a micro-core component by the target domain transaction component; determining, through the micro-core component, a resource type associated with the transaction execution result; and determining, through the micro-core component based on transaction execution result and the resource type associated with the transaction execution result, a transfer relationship between account numbers associated with the transaction task, and performing transfer accounting processing on resources of the account numbers based on the transfer relationship.

Cloud computing is a computing mode, in which computing tasks are distributed on a resource pool formed by a large quantity of computers, so that various application systems can obtain computing power, storage space, and information services as required. A network providing a resource is referred to as a “cloud”. For a user, resources in the “cloud” seem to be infinitely expandable, and may be obtained readily, used on demand, expanded readily, and paid for use.

As a basic capability provider of the cloud computing, a cloud computing resource pool (a cloud platform for short, and generally referred to as an infrastructure as a service (IaaS) platform) is established, and a plurality of types of virtual resources are deployed in the resource pool, to be selected by an external customer for use. The cloud computing resource pool mainly includes: a computing device (which is a virtualization machine, and includes an operating system), a storage device, and a network device.

According to logical function division, a platform as a service (PaaS) layer may be deployed on the infrastructure as a service (IaaS) layer, and a software as a service (SaaS) layer may be deployed on the PaaS layer, or the SaaS may be directly deployed on the IaaS. The PaaS is a platform on which software runs, such as a database and a web container. The SaaS is various types of service software, such as a web portal site and a short message service message group transmitter. Generally, the SaaS and the PaaS are upper layers relative to the IaaS.

The solutions provided in the embodiments of the present disclosure relate to a cloud computing technology in the cloud computing field, and are specifically described by using the following embodiments.

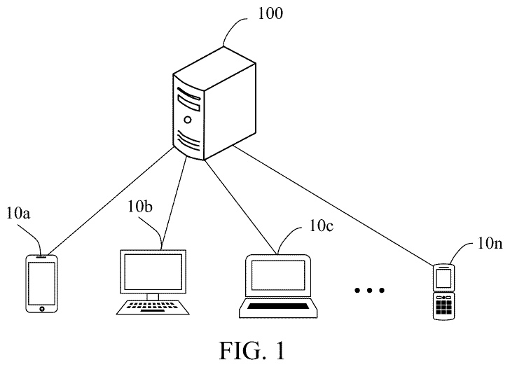

Refer to FIG. 1. FIG. 1 is a schematic diagram of a network architecture according to an embodiment of the present disclosure. As shown in FIG. 1, the network architecture may include an application server 100 and a terminal device cluster. The terminal device cluster may include a plurality of terminal devices. As shown in FIG. 1, the terminal device cluster may include a terminal device 10a, a terminal device 10b, a terminal device 10c, . . . , and a terminal device 10n. As shown in FIG. 1, the terminal device 10a, the terminal device 10b, the terminal device 10c, . . . , and the terminal device 10n may separately be connected to the application server 100 through a network, so that each terminal device can perform a data interaction with the application server 100 through the network, so that each terminal device can receive service data from the application server 100.

An application client corresponding to a target application may be integrally installed on each terminal device in the terminal device cluster shown in FIG. 1. When running in each terminal device, the application client may perform a data interaction with the application server 100 shown in FIG. 1, so that the application server 100 can receive service data from each terminal device. The application client may be a game application, a video editing application, a social application, an instant messaging application, a live broadcast application, a short video application, a video application, a music application, a shopping application, a novel application, a payment application, a browser, and other application clients with functions of displaying text, images, an audio, a video, and other data information The application client may be an independent client or an embedded sub-client integrated in a client (such as an instant messaging client, a social client, or a video client). This is not limited herein.

As shown in FIG. 1, one or more domain transaction components and a micro-core component may be integrally installed in the application server 100. One domain transaction component corresponds to one domain transaction scenario, and is configured to process a transaction task that is in the domain transaction scenario and that is transmitted by a terminal device. For example, the domain transaction component may be an insurance transaction component, and the insurance transaction component is responsible for processing a transaction task in the insurance transaction scenario. The micro-core component is configured to account and transfer a transaction resource used in a transaction task. The transaction resource may include a digital resource and a balance resource. The balance resource is a traditional offline resource that serves as a general equivalent during a transaction. The digital resource is a virtual resource based on a node network and a digital encryption algorithm.

During actual implementation, any terminal device in the terminal device cluster may transmit a transaction task in a target domain transaction scenario to the application server 100. The application server 100 may receive, through a target domain transaction component among the at least one domain transaction component, a transaction task in a target field corresponding to the target domain transaction component, and execute the transaction task, to obtain a transaction execution result; transmit the transaction execution result to the micro-core component through the target domain transaction component; determine, through the micro-core component, a resource type associated with the transaction execution result; and determine, through the micro-core component based on the transaction execution result and the resource type associated with the transaction execution result, a transfer relationship between account numbers associated with the transaction task, and perform transfer accounting processing on resources of the account numbers based on the transfer relationship.

The foregoing network connection is not limited to a connection manner, and may be connected directly or indirectly through wired communication, or directly or indirectly through wireless communication, or may further be connected in another connection manner. This is not limited in the present disclosure.

A method provided in embodiments of the present disclosure may be performed by an electronic device. The electronic device includes, but is not limited to, a terminal device or an application server. The application server may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device may be a mobile phone, a tablet computer, a notebook computer, a palmtop computer, a smart speaker, a mobile Internet device (MID), a point of sale (POS) machine, a wearable device (such as a smart watch or a smart bracelet), or the like.

The foregoing device (such as the application server 100, the terminal device 10a, the terminal device 10b, the terminal device 10c, . . . , or the terminal device 10n) may be a node in a distributed system. The distributed system may be a blockchain system, and the blockchain system may be a distributed system formed by connecting a plurality of nodes through network communication. A peer-to-peer (P2P) network is formed between the nodes. A P2P protocol is an application-layer protocol running over the Transmission Control Protocol (TCP). In the distributed system, an electronic device in any form, such as a server or a terminal, may become a node in the blockchain system by joining the peer-to-peer network.

The embodiments of the present disclosure may be applied to various scenarios, including but not limited to scenarios of cloud technologies, artificial intelligence, blockchains, insurance, wealth management, smart wallets, and the like.

In a specific implementation of the present disclosure, relevant data such as a transaction task is used. When the foregoing embodiments of the present disclosure are applied to a specific product or technology, a permission or a consent of a user needs to be obtained, and collection, use, and processing of the relevant data need to comply with relevant laws, regulations, and standards of relevant countries and regions.

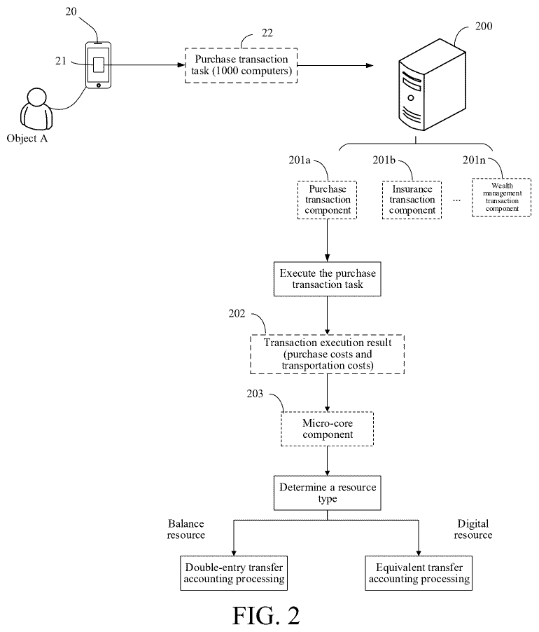

For ease of understanding the foregoing integrated accounting process of the digital resource and the balance resource, a purchase transaction scenario is used as an example for description. FIG. 2 is a schematic diagram of a scenario of resource transfer and accounting according to an embodiment of the present disclosure. A terminal device 20 shown in FIG. 2 may be any terminal device in the terminal device cluster shown in FIG. 1. For example, the terminal device 20 may be the terminal device 10a. An application server 200 shown in FIG. 2 may be the application server 100 shown in FIG. 1.

As shown in FIG. 2, a purchase application 21 may be integrally installed in the terminal device 20. The purchase application 21 may match a most suitable purchase plan for an object according to a requirement of the object and costs. Assuming that an object A has an association relationship with the terminal device 20, and the object A needs to purchase 1000 computers, the object A may perform a purchase operation through the purchase application 21, and the terminal device 20 may generate a purchase transaction task 22 in response to the purchase operation of the object A, and transmit the purchase transaction task 22 to the application server 200.

As shown in FIG. 2, one or more domain transaction components may be integrally installed in the application server 200. Different domain transaction components correspond to different domain transaction scenarios, that is, are configured to process transaction tasks in the different domain transaction scenarios. For example, the application server 200 may include a purchase transaction component 201a, an insurance transaction component 201b, . . . , and a wealth management transaction component 201n. The purchase transaction component 201a is configured to process a transaction task in the purchase transaction scenario. The insurance transaction component 201b is configured to process a transaction task in an insurance transaction scenario. The wealth management transaction component 201n is configured to process a transaction task in a wealth management transaction scenario. After receiving the purchase transaction task 22, the application server 200 may transmit the purchase transaction task 22 to the purchase transaction component 201a. After receiving the purchase transaction task 22 through the purchase transaction component 201a, the application server 200 may execute the purchase transaction task 22. For example, the application server 200 may match a plurality of purchase plans for the object A in the purchase transaction component 201a based on a purchase requirement of the object A included in the purchase transaction task 22, and return the plurality of purchase plans to the terminal device 20. The object A may select and confirm a target purchase plan from the plurality of purchase plans through the terminal device 20. After receiving confirmation information for the target purchase plan, the application server 200 may execute the target purchase plan through the purchase transaction component 201a, to obtain a transaction execution result 202. The transaction execution result 202 may include purchase costs and transportation costs corresponding to the target purchasing plan. Then, the application server 200 may transmit the transaction execution result 202 to a micro-core component 203 through the purchase transaction component 201a. The micro-core component 203 is a component integrally installed in the application server 200, and is configured to be responsible for accounting and a resource transfer. Each domain transaction component included in the application server 200 may communicate with the micro-core component 203, to complete accounting and a resource transfer of a corresponding transaction task.

As shown in FIG. 2, the application server 200 may first determine, in the micro-core component 203, a resource type associated with the transaction execution result, that is, whether a resource used in this transaction task is a digital resource or a balance resource. If it is determined that the resource type is a balance resource type, the application server 200 may determine, based on the transaction execution result, a balance transfer relationship between S first account numbers associated with the transaction task. The S first account numbers associated with the transaction task may include a first account number corresponding to the object A, a first account number corresponding to a computer manufacturer, and a first account number corresponding to a transportation manufacturer. Then, the application server 200 may perform double-entry transfer accounting processing on balance resources of the S first account numbers based on the balance transfer relationship. If it is determined that the resource type is a digital resource type, the application server 200 may determine, based on the transaction execution result, a balance transfer relationship between L second account numbers associated with the transaction task. The L second account numbers associated with the transaction task may include a second account number corresponding to the object A, a second account number corresponding to a computer manufacturer, and a second account number corresponding to a transportation manufacturer. Then, the application server 200 may perform equivalent transfer accounting processing on digital resources of the L second account numbers based on the balance transfer relationship.

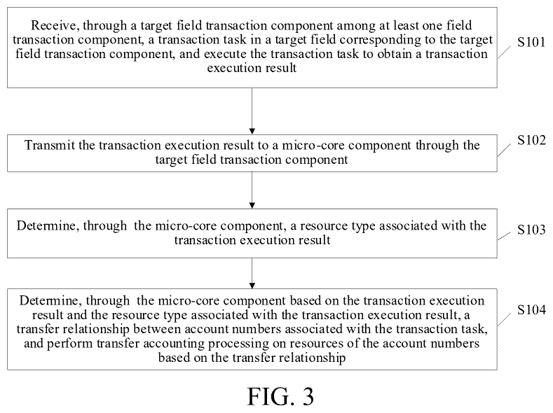

During actual implementation, refer to FIG. 3. FIG. 3 is a schematic flowchart of a data processing method according to an embodiment of the present disclosure. The method may be executed by an electronic device (for example, the application server 100 in the embodiment corresponding to FIG. 1). The electronic device includes at least one domain transaction component and a micro-core component. The following provides descriptions by using an example in which the method is executed by the electronic device. The data processing method may include at least the following operation S101 to operation S104.

Operation S101: Receive, through a target domain transaction component among the at least one domain transaction component, a transaction task in a target field corresponding to the target domain transaction component, and execute the transaction task, to obtain a transaction execution result.

During actual implementation, logic and manners of implementing transaction tasks in different domain transaction scenarios are greatly different, and more factors and requirements need to be considered for a transaction task in a more complex domain transaction scenario. For example, in a shopping transaction scenario, only a buyer, a seller, and a commodity price usually need to be considered in a transaction task. In a wealth management transaction scenario, a buyer, an issuer of a wealth management product, a profit rate, a risk rate, liquidity, and the like need to be considered in a transaction task. Therefore, different domain transaction scenarios may be abstracted, and transaction tasks in different domain transaction scenarios are implemented by different domain transaction components. Each domain transaction component needs to focus on processing and implementation of a transaction task only in a corresponding domain transaction scenario. In some embodiments, when a new domain transaction scenario needs to be obtained through expansion, a new domain transaction component may be created to be responsible for a transaction task in the new domain transaction scenario, so that a transaction task in an original domain transaction scenario is not affected, thereby facilitating expansion of a domain transaction scenario.

Operation S102: Transmit the transaction execution result to the micro-core component through the target domain transaction component.

Operation S103: Determine, through the micro-core component, a resource type associated with the transaction execution result.

During actual implementation, the resource type includes a balance resource type and a digital resource type. The resource type associated with the transaction execution result is a balance resource type, indicating that a resource used in the transaction execution result is a balance resource. The resource type associated with the transaction execution result is a digital resource type, indicating that a resource used in the transaction execution result is a digital resource.

In some embodiments, before the resource type associated with the transaction execution result is determined, a transaction certificate for the transaction execution result may be generated through the target domain transaction component, and the transaction certificate is transmitted to the micro-core component. Verification processing is performed on the transaction certificate through the micro-core component, to obtain a verification result. If the verification result is a verification success result, the operation of determining a resource type associated with the transaction execution result is performed.

The transaction certificate may be understood as a document, and is a certificate that can be configured to prove that a transaction execution result definitely happens or completes, to clarify economic responsibility. Whether a transaction execution result corresponding to each transaction task happens or completes may be checked at any time by using the transaction certificate. Therefore, the transaction certificate may be used as an original basis for accounting.

In some embodiments, the transaction certificate may include signature data. A feasible implementation process of performing verification processing on the transaction certificate through the micro-core component, to obtain a verification result may be: determining, through the micro-core component, a public key certificate associated with the target domain transaction component; performing signature verification processing on the signature data based on the public key certificate, to obtain a signature verification result; and if the signature verification result is a signature verification success result, determining that the verification result is a verification success result; or if the signature verification result is a signature verification failure result, determining that the verification result is a verification failure result.

Operation S104: Determine, through the micro-core component based on the transaction execution result and the resource type associated with the transaction execution result, a transfer relationship between account numbers associated with the transaction task, and perform transfer accounting processing on resources of the account numbers based on the transfer relationship.

During actual implementation, as described above, the resource type includes the balance resource type and the digital resource type. The resource type associated with the transaction execution result is a balance resource type, indicating that a resource used in the transaction execution result is a balance resource. The resource type associated with the transaction execution result is a digital resource type, indicating that a resource used in the transaction execution result is a digital resource. Based on this, the following separately describes cases in which the resource type is the balance resource type and the resource type is the digital resource type.

In some embodiments, when the resource type is the balance resource type, the process of determining, based on the transaction execution result and the resource type associated with the transaction execution result, a transfer relationship between account numbers associated with the transaction task may be a process of determining, based on the transaction execution result, a balance transfer relationship between S first account numbers associated with the transaction task. Therefore, the process of performing transfer accounting processing on resources of the account numbers based on the transfer relationship may be a process of performing double-entry transfer accounting processing on balance resources of the S first account numbers based on the balance transfer relationship. S is a positive integer.

The micro-core component may include a transaction accounting layer and an object resource layer. The transaction accounting layer is used for accounting, and the object resource layer is used for a resource transfer between different objects.

Based on this, the process of determining, based on the transaction execution result, a balance transfer relationship between S first account numbers associated with the transaction task may be: determining, in the transaction accounting layer based on the transaction execution result, the balance transfer relationship between the S first account numbers associated with the transaction task. Therefore, the process of performing double-entry transfer accounting processing on balance resources of the S first account numbers based on the balance transfer relationship may be: performing the double-entry accounting processing on the S first account numbers based on the balance transfer relationship, to obtain a double-entry accounting result. If the double-entry accounting result is a double-entry accounting success result, balance resource management account numbers respectively corresponding to the S first account numbers are determined in the object resource layer. One balance resource management account number is used for managing balance resources of one or more first account numbers. The balance resources of the S first account numbers are transferred based on the balance transfer relationship and the balance resource management account numbers respectively corresponding to the S first account numbers.

Double-entry accounting is an accounting method in which for each transaction task, equal amounts are required to be registered in two or more interrelated account numbers through a balance relationship between an asset and equity as an accounting basis, to systematically reflect a resource movement change result. In other words, a result of each transaction task is recorded in at least one account number of a debit and at least one account number of a credit, and a total amount of the debit and a total amount of the credit of the transaction task are equal, that is, “every transaction includes a debit and a credit, and the debit and the credit are required to be equal”. An account number type of the first account number may include a balance resource management type and a balance resource usage type. If the account number type of the first account number is the balance resource management type, the first account number may store a balance resource, and a balance resource management account number corresponding to the first account number is the first account number. If the account number type of the first account number is the balance resource usage type, the first account number may not store a balance resource, but may store a balance resource of the first account number in a first account number of the balance resource management type, and the first account number of the balance resource management type is a balance resource management account number corresponding to the first account number of the balance resource usage type. A plurality of first account numbers of the balance resource usage type may store balance resources of the first account numbers in the same first account number of the balance resource management type.

A feasible implementation process of performing the double-entry accounting processing on the S first account numbers based on the balance transfer relationship, to obtain a double-entry accounting result may be: based on the balance transfer relationship, determining first account numbers that are among the S first account numbers and that are of a debit type as first debit account numbers, and determining first account numbers that are among the S first account numbers and that are of a credit type as first credit account numbers; determining, based on the balance transfer relationship, debit balances respectively corresponding to the first debit account numbers; determining, based on the balance transfer relationship, credit balances respectively corresponding to the first credit account numbers; and if a sum of the debit balances respectively corresponding to the first debit account numbers is equal to a sum of the credit balances respectively corresponding to the first credit account numbers, recording the debit balances respectively corresponding to the first debit account numbers and the credit balances respectively corresponding to the first credit account numbers, and determining that the double-entry accounting result is a double-entry accounting success result. When S is two, the balance transfer relationship may include a one-debit-one-credit relationship. When S is an integer greater than 2, the balance transfer relationship may include a one-debit-multiple-credit relationship and a multiple-debit-multiple-credit relationship. The one-debit-one-credit relationship is that a quantity of first debit account numbers is one and a quantity of first credit account numbers is one. The one-debit-multiple-credit relationship is that a quantity of first debit account numbers is one and a quantity of first credit account numbers is multiple. The multiple-debit-multiple-credit relationship is that a quantity of first debit account numbers is multiple and a quantity of first credit account numbers is multiple.

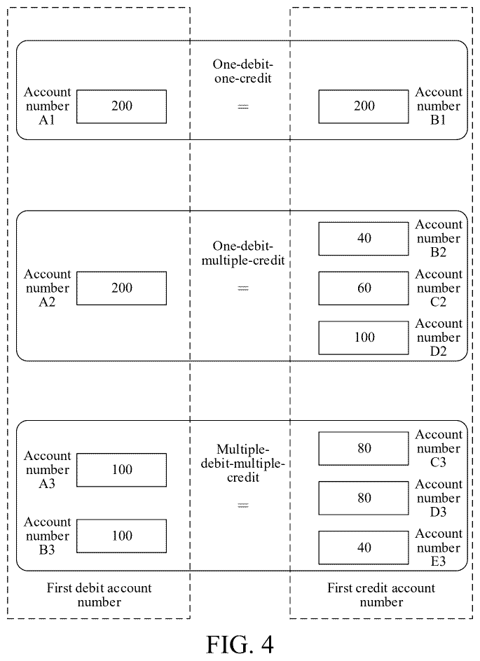

For ease of understanding of a double-entry accounting process of the S first account numbers, FIG. 4 is a schematic diagram of a double-entry accounting process according to an embodiment of the present disclosure. As shown in FIG. 4, when the balance transfer relationship is the one-debit-one-credit relationship, for example, when an account number A1 needs to transfer balance resources whose quantity is 200 to an account number B1, in the transaction accounting layer, it is necessary to record that a debit balance of the account number A1 is 200 and a credit balance of the account number B1 is 200. When the balance transfer relationship is the one-debit-multiple-credit relationship, for example, when an account number A2 needs to transfer balance resources whose quantity is 40 to an account number B2, the account number A2 needs to transfer balance resources whose quantity is 60 to an account number C2, and the account number A2 needs to transfer balance resources whose quantity is 100 to an account number D2, in the transaction accounting layer, it is necessary to record that a credit balance of the account number B2 is 40, a credit balance of the account number C2 is 60, a credit balance of the account number D2 is 100, and a debit balance of the account number A2 is 200. When the balance transfer relationship is the multiple-debit-multiple-credit relationship, for example, when an account number A3 and an account number B3 each provide balance resources whose quantity is 100, and then together transfer balance resources whose quantity is 80 to an account number C3, balance resources whose quantity is 80 to an account number D3, and balance resources whose quantity is 40 to an account number E3, in the transaction accounting layer, it may be recorded that a debit balance of the account number A3 is 100, a debit balance of the account number B3 is 100, a credit balance of the account number C3 is 80, a credit balance of the account number D3 is 80, and a credit balance of the account number E3 is 40. Before accounting is performed in the transaction accounting layer, it is necessary to first verify whether the sum of the debit balances respectively corresponding to the first debit account numbers is equal to the sum of the credit balances respectively corresponding to the first credit account numbers. Only when the sum of the debit balances respectively corresponding to the first debit account numbers is equal to the sum of the credit balances respectively corresponding to the first credit account numbers, the debit balances respectively corresponding to the first debit account numbers and the credit balances respectively corresponding to the first credit account numbers are recorded, thereby determining that the double-entry accounting result is a double-entry accounting success result. As shown in FIG. 4, the debit balance of the account number A1 is equal to the credit balance of the account number B1, the debit balance of the account number A2 is equal to a sum of the credit balances respectively corresponding to the account number B2, the account number C2, and the account number D2, and a sum of the debit balance of the account number A3 and the debit balance of the account number B3 is equal to a sum of the credit balances respectively corresponding to the account number C3, the account number D3, and the account number E3.

During actual implementation, a feasible implementation process of transferring the balance resources of the S first account numbers based on the balance transfer relationship and the balance resource management account numbers respectively corresponding to the S first account numbers may be: if the balance resource management account numbers respectively corresponding to the S first account numbers are the same, performing value update processing on account number balances in the S first account numbers based on the balance transfer relationship, one account number balance being configured to represent a quantity of balance resources that can be exchanged by one first account number from a balance resource management account number; and if the balance resource management account numbers respectively corresponding to the S first account numbers are different, transferring, based on the balance transfer relationship, balance resources of the balance resource management account numbers respectively corresponding to the S first account numbers, to obtain a balance resource transfer result; and performing value update processing on account number balances in the S first account numbers based on the balance resource transfer result.

For ease of understanding, descriptions are provided by using an example in which the S first account numbers include a first account number X and a first account number Y and the balance transfer relationship is that the first account number X transfers balance resources whose quantity is 10 to the first account number Y. It is assumed that an account number balance of the first account number X is 50 and an account number balance of the first account number Y is 60.

If both balance resource management account numbers corresponding to the two first account numbers are a management account number Z1, it may be considered that a quantity of balance resources that can be exchanged by the first account number X from the management account number Z1 is 50, and that a quantity of balance resources that can be exchanged by the first account number Y from the management account number Z1 is 60. Both the two first account numbers may exchange the balance resources from the management account number Z1. Therefore, it may be considered that the balance resources of the two are stored in the management account number Z1. In this case, the balance resources do not need to be transferred, and only value update processing needs to be performed on the account number balance of the first account number X and the account number balance of the first account number Y based on the balance transfer relationship, to obtain the account number balance of the first account number X being 40, and the account number balance of the first account number Y being 70. It may be considered that transfer processing on the balance resources of the first account number X and the balance resources of the first account number Y is completed, because in this case, a quantity of balance resources that can be exchanged by the first account number X from the management account number Z1 is reduced to 40, while a quantity of balance resources that can be exchanged by the first account number Y from the management account number Z1 is increased to 70.

If a balance resource management account number corresponding to the first account number X is a management account number Z2, and a balance resource management account number corresponding to the first account number Y is a management account number Z3, because balance resources of the two first account numbers are stored in different balance resource management account numbers, it is necessary to transfer balance resources whose quantity is 10 from the management account number Z2 to the management account number Z3. Clearly, after the transfer is completed, a quantity of balance resources that can be exchanged by the first account number X from the management account number Z2 is reduced to 40. In this case, the account number balance of the first account number X needs to be updated to 40. A quantity of balance resources that can be exchanged by the first account number Y from the management account number Z3 is increased to 70. In this case, the account number balance of the first account number Y needs to be updated to 70.

In some other embodiments, when the resource type is the digital resource type, the process of determining, based on the transaction execution result and the resource type associated with the transaction execution result, a transfer relationship between account numbers associated with the transaction task may be a process of determining, based on the transaction execution result, a digital resource transfer relationship between L second account numbers associated with the transaction task. Therefore, the process of performing equivalent transfer accounting processing on digital resources of the L second account numbers based on the digital resource transfer relationship may be performing equivalent transfer accounting processing on the digital resources of the L second account numbers based on the digital resource transfer relationship. L is a positive integer. Among the L second account numbers on which equivalent accounting processing is performed, a total quantity of transferred-out digital resources corresponding to second account numbers of a transfer output type is equal to a total quantity of transferred-in digital resources corresponding to second account numbers of a transfer input type.

The total quantity of transferred-out digital resources corresponding to the second account numbers of the transfer output type is equal to a sum of quantities that are of transferred-out unit digital resources and that are respectively corresponding to second transfer-out account numbers. The total quantity of transferred-in digital resources corresponding to the second account numbers of the transfer input type is equal to a sum of quantities that are of transferred-in unit digital resources and that are respectively corresponding to second transfer-in account numbers. In addition, as described above, the micro-core component may include a transaction accounting layer and an object resource layer. The transaction accounting layer is used for accounting, and the object resource layer is used for a resource transfer between different objects.

Based on this, the process of determining, based on the transaction execution result, a digital resource transfer relationship between the L second account numbers associated with the transaction task may be: determining, in the transaction accounting layer based on the transaction execution result, the digital resource transfer relationship between of the L second account numbers associated with the transaction task. Therefore, the process of performing equivalent transfer accounting processing on the digital resources of the L second account numbers based on the digital resource transfer relationship may be: performing the equivalent accounting processing on the digital resources of the L second account numbers based on the digital resource transfer relationship, to obtain an equivalent accounting result. If equivalent accounting result is an equivalent accounting success result, digital resource transfer processing is performed on the digital resources of the L second account numbers based on the digital resource transfer relationship.

Equivalent accounting is that in each transaction task, an accounting equation is required to be kept balanced, that is, a quantity of transferred-out unit digital resources and a quantity of transferred-in unit digital resources in each transaction task need to be equal. The second account number may include an account number address, and the account number address is configured to store a digital resource of the second account number. Different second account numbers correspond to different account number addresses.

A feasible implementation process of performing the equivalent accounting processing on the digital resources of the L second account numbers based on the digital resource transfer relationship, to obtain an equivalent accounting result may be: based on the digital resource transfer relationship, determining second account numbers that are among the L second account numbers and that are of a transfer output type as second transfer-out account numbers, and determining second account numbers that are among the L second account numbers and that are of a transfer input type as second transfer-in account numbers; determining, based on the digital resource transfer relationship, quantities that are of transferred-out unit digital resources and that are respectively corresponding to the second transfer-out account numbers; determining, based on the digital resource transfer relationship, quantities that are of transferred-in unit digital resources and that are respectively corresponding to the second transfer-in account numbers; and if a sum of the quantities that are of transferred-out unit digital resources and that are respectively corresponding to the second transfer-out account numbers is equal to a sum of the quantities that are of transferred-in unit digital resources and that are respectively corresponding to the second transfer-in account numbers, recording the quantities that are of transferred-out unit digital resources and that are respectively corresponding to the second transfer-out account numbers and the quantities that are of transferred-in unit digital resources and that are respectively corresponding to the second transfer-in account numbers, and determining that the equivalent accounting result is an equivalent accounting success result.

The quantity of transferred-out unit digital resources is a quantity of unit digital resources included in a digital resource transferred out by the second transfer-out account number, and the unit digital resource is a reference standard for measuring a quantity of digital resources and may change depending on actual settings. The quantity of transferred-in unit digital resources is a quantity of unit digital resources included in a digital resource obtained by the second transfer-in account number.

During actual implementation, in the object resource layer, when the digital resource transfer processing is performed on the digital resources of the L second account numbers based on the digital resource transfer relationship, if L is 2, the digital resource transfer relationship may include a one-out-one-in relationship. In this case, a digital resource of the second transfer-out account number may be transferred to the second transfer-in account number through a direct transfer transaction. If L is an integer greater than 2, the digital resource transfer relationship may include a one-out-multiple-in relationship and a multiple-out-one-in relationship. When the digital resource transfer relationship is the one-out-multiple-in relationship, a digital resource of the second transfer-out account number may be transferred to the second transfer-in account number through a splitting transfer transaction. When the digital resource transfer relationship is the multiple-out-one-in relationship, a digital resource of the second transfer-out account number may be transferred to the second transfer-in account number through a merging transfer transaction. The direct transfer transaction is a full transfer of the digital resource from one trading party to another. The splitting transfer transaction is to split a digital resource of one trading party into a plurality of smaller denominations, and then to transfer the digital resources obtained through splitting to another trading party. The merging transfer transaction is to merge digital resources of a plurality of trading parties into a larger denomination, and then to transfer the digital resource obtained through merging to another trading party.

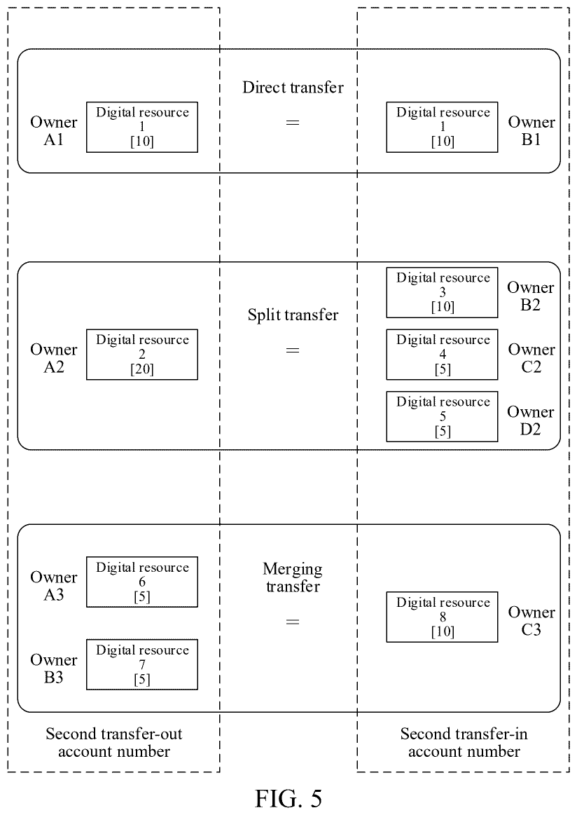

For ease of understanding of a process of performing digital resource transfer processing on the L second account numbers, FIG. 5 is a schematic diagram of a digital resource transfer process according to an embodiment of the present disclosure. As shown in FIG. 5, when the digital resource transfer relationship is the one-in-one-out relationship, for example, when an owner A1 needs to transfer 10 unit digital resources to an owner A2, in the object resource layer, a digital resource 1 including 10 unit digital resources may be directly transferred through a direct transfer transaction, and an owner of the digital resource 1 is changed from the owner A1 to the owner A2. As shown in FIG. 5, when the digital resource transfer relationship is the one-out-multiple-in relationship, for example, when an owner A2 needs to respectively transfer 10 unit digital resources to an owner B2, 5 unit digital resources to an owner C2, and 5 unit digital resources to an owner D2, in the object resource layer, a digital resource 2 including 20 unit digital resources may be split and transferred through a splitting transfer transaction, to obtain a digital resource 3 including 10 unit digital resources, a digital resource 4 including 5 unit digital resources, and a digital resource 5 including 10 unit digital resources. The digital resource 3 belongs to the owner B2, the digital resource 4 belongs to the owner C2, and the digital resource 5 belongs to the owner D2. As shown in FIG. 5, when the digital resource transfer relationship is the multiple-out-one-in relationship, for example, when an owner A3 and an owner B3 together need to transfer 10 unit digital resources to an owner C3, in the object resource layer, a digital resource 6 including 5 unit digital resources and a digital resource 7 including 5 unit digital resources may be merged and transferred through a merging transfer transaction, to obtain a digital resource 8 including 10 unit digital resources. The digital resource 8 belongs to the owner C3. The above owner may be an account number address corresponding to the second account number. During transferring of a digital resource, the sum of the quantities that are of transferred-out unit digital resources and that are respectively corresponding to the second transfer-out account numbers is required to be equal to the sum of the quantities that are of transferred-in unit digital resources and that are respectively corresponding to the second transfer-in account numbers.

In some embodiments, the electronic device may record a digital resource balance corresponding to a digital resource owned by each second account number in the object resource layer. The digital resource balance may be a sum of quantities of unit digital resources included in digital resources owned by the second account number. For example, a second account number W may own a digital resource 9 and a digital resource 10, where the digital resource 9 includes 5 unit digital resources and the digital resource 10 includes 12 unit digital resources. In this case, a digital resource balance corresponding to the second account number may be 17.

Based on the method provided in this embodiment of the present disclosure, transaction tasks in different domain transaction scenarios are completed by corresponding domain transaction components, and a transfer accounting process of the digital resource or the balance resource is uniformly completed by the micro-core component. An execution process of a transaction task is decoupled from a transfer accounting process of the digital resource or the balance resource used in the transaction task, so that integrated accounting can be implemented on the digital resource and the balance resource in a plurality of domain transaction scenarios.

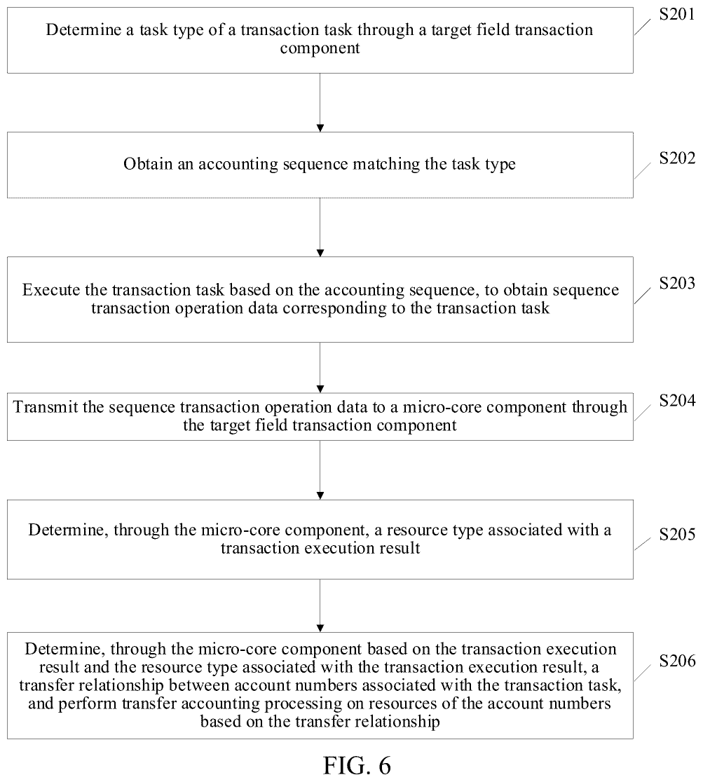

During actual implementation, refer to FIG. 6. FIG. 6 is a schematic flowchart of a data processing method according to an embodiment of the present disclosure. The method may be executed by an electronic device (for example, the application server 100 in the embodiment corresponding to FIG. 1). The following provides descriptions by using an example in which the method is executed by the electronic device. The data processing method may include at least the following operation S201 to operation S206.

Operation S201: Determine a task type of a transaction task through a target domain transaction component.

Operation S202: Obtain an accounting sequence matching the task type.

During actual implementation, the accounting sequence is a sequence of a series of accounting operations that are predetermined in a specific service scenario through definition by a business rule and logic. These operations may include an asset transfer, transaction confirmation, fund settlement, and the like. A task type of each transaction task may correspond to a specific service scenario in a domain transaction scenario to which the transaction task belongs. Therefore, one or more common configuration task type may be pre-configured, an accounting sequence may be pre-made for each configuration task type, and the accounting sequence and the corresponding configuration task type are stored, for example, in an accounting sequence database.

During actual implementation, if the accounting sequence database includes one or more configuration task types and an accounting sequence bound to each configuration task type, a feasible implementation process of obtaining an accounting sequence matching the task type may be: obtaining an accounting sequence database associated with the target domain transaction component; and determining, as the accounting sequence matching the task type, an accounting sequence bound to a configuration task type that is the same as the task type in the accounting sequence database.

Operation S203: Execute the transaction task based on the accounting sequence, to obtain sequence transaction operation data corresponding to the transaction task.

A transaction execution result includes the sequence transaction operation data. Executing the transaction task based on the accounting sequence, to obtain the sequence transaction operation data corresponding to the transaction task is executing the transaction task based on the accounting sequence, to obtain the transaction execution result corresponding to the transaction task.

During actual implementation, in a feasible embodiment, the accounting sequence may include M accounting operations, M being a positive integer. A feasible implementation process of executing the transaction task based on the accounting sequence, to obtain sequence transaction operation data corresponding to the transaction task may be: traversing the M accounting operations, and obtaining a k^{th} accounting operation, k is a positive integer less than or equal to K; executing the transaction task based on the k^{th} accounting operation and k−1 pieces of transaction operation data, to obtain a k^{th} piece of transaction operation data; and when traversing the M accounting operations is completed, determining k pieces of transaction operation data as the sequence transaction operation data.

One accounting operation may be used for obtaining one piece of transaction operation data. The transaction operation data may alternatively be considered as a type of accounting information. Accounting information that can be obtained includes an accounting subject, debit and credit directions, an amount, and other information. The accounting information obtained through the accounting operation in the accounting sequence forms a series of standard accounting entry sequences, that is, the sequence transaction operation data.

Operation S204: Transmit the sequence transaction operation data to a micro-core component through the target domain transaction component.

During actual implementation, as described above, the transaction execution result includes the sequence transaction operation data. Executing the transaction task based on the accounting sequence, to obtain the sequence transaction operation data corresponding to the transaction task is executing the transaction task based on the accounting sequence, to obtain the transaction execution result corresponding to the transaction task. Based on this, the sequence transaction operation data is transmitted to the micro-core component through the target domain transaction component, that is, the transaction execution result is transmitted to the micro-core component through the target domain transaction component.

Operation S205: Determine, through the micro-core component, a resource type associated with the transaction execution result.

Operation S206: Determine, through the micro-core component based on the transaction execution result and the resource type associated with the transaction execution result, a transfer relationship between account numbers associated with the transaction task, and perform transfer accounting processing on resources of the account numbers based on the transfer relationship.

During actual implementation, for implementations of operation S205 and operation S206, refer to the descriptions of operation S103 and operation S104 in the embodiment corresponding to FIG. 3. Details are not described herein again.

Based on the method provided in this embodiment of the present disclosure, accounting sequences are pre-made for transaction tasks of different task types, so that sequence transaction operation data of each transaction business may be quickly and accurately obtained. The sequence transaction operation data may be used as an accounting entry of the transaction business, thereby avoiding an error and an omission in a manual operation, and also providing an accurate and reliable data basis for subsequent accounting in the micro-core component.

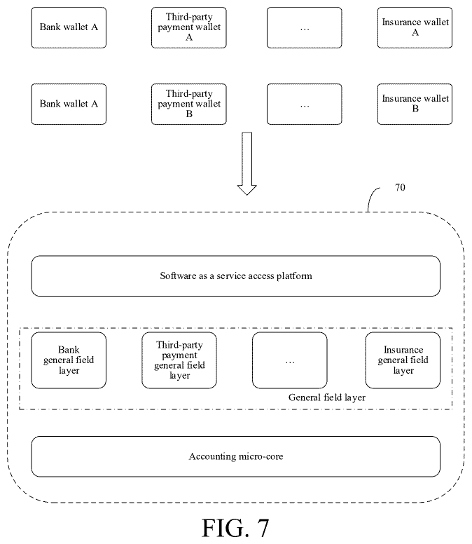

During actual implementation, refer to FIG. 7. FIG. 7 is a schematic diagram of a product of an accounting system according to an embodiment of the present disclosure. As shown in FIG. 7, the accounting system 70 provided in this embodiment of the present disclosure may include a software as a service (SaaS) platform, a general field layer, and an accounting micro-core. The SaaS platform is used for implementing product SaaS-ization on the accounting system. The product SaaS-ization is reconstructing and reforming a conventional standalone software product or service, converting the conventional standalone software product or service into a cloud-based service mode based on a cloud computing technology and a network technology, and providing the cloud-based service mode to a user for use through a network. As long as the user accesses a cloud service through the network, the user may use a software function anywhere at any time without caring about software installation, configuration, update, and other problems or without caring about problems in aspects such as a software running environment and hardware equipment. In this way, software usage efficiency and user experience can be greatly improved. As shown in FIG. 7, in domain transaction scenarios corresponding to banking, third-party payment, insurance, or various applications, a corresponding wallet may be integrally installed on a terminal side, and the terminal side performs a data interaction with the SaaS platform by using the wallet, to perform a transaction task in a corresponding domain transaction scenario. The general field layer is obtained after general field abstraction is performed on a domain transaction scenario, and the general field layer may be implemented by the domain transaction component described in the embodiment corresponding to FIG. 3. The accounting micro-core is actually implemented by the micro-core component described in the embodiment corresponding to FIG. 3. The accounting system 70 shown in FIG. 7 may provide a one-stop accounting SaaS service for a transaction task in each domain transaction scenario.

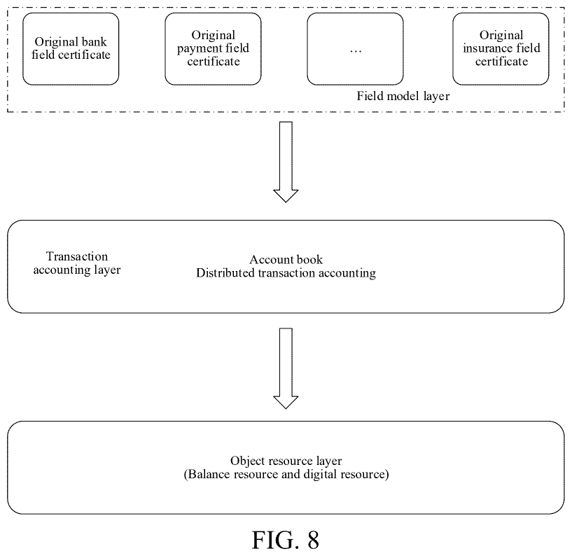

FIG. 8 is a schematic architectural diagram of an accounting system according to an embodiment of the present disclosure. As shown in FIG. 8, the accounting system may be divided into three layers in implementation, namely, a field model layer, a transaction accounting layer, and an object resource layer. As shown in FIG. 8, the field model layer is mainly configured to implement the general field layer shown in FIG. 7. The field model layer may be split into business field subsystems based on a microservice idea, that is, a banking general field layer, a third-party payment general field layer, and the like shown in FIG. 7. Each of the business field subsystems may execute a corresponding transaction task by using an accounting sequence pre-made in a business field. Refer to the implementation of operation S203 in the embodiment corresponding to FIG. 6. Details are not described herein again. In addition, as shown in the figure, different general field layers in the field model layer may generate different transaction certificates after executing a corresponding transaction task, such as an original banking field certificate, an original payment field certificate, and an original insurance field certificate. These transaction certificates may be configured to prove that the transaction task has already occurred or completed. As shown in FIG. 8, the transaction accounting layer is responsible for a distributed accounting transaction and performs an accounting entry level, thereby ensuring an equivalent transfer balance of M-in-N-out digital resources and a double-entry transfer balance of balance resources. As shown in FIG. 8, the object resource layer is mainly responsible for managing or transferring a digital resource or a balance resource. For application of the transaction accounting layer and the object resource layer, refer to the descriptions of operation S104 in the embodiment corresponding to FIG. 3. Details are not described herein again.

For the object resource layer, a field in which an object resource or a balance resource is used does not need to be understood, that is, an architecture of the accounting system provided in this embodiment of the present disclosure may implement decoupling of accounting, a resource transfer, and a transaction task, thereby improving the expansibility of the accounting system.

The accounting system shown in FIG. 8 is configured to implement a resource transfer balance based on the transaction certificate. When accounting is performed on the first account number associated with the balance resource or the second account number associated with the digital resource by using the accounting system, if the account number needs to be operated, the account number may be operated by using an account number operation model. In the account number operation model, a necessary operation primitive may be defined, and a sub-closed-loop full enumeration space operation is defined for an account number and a resource (the balance resource or the digital resource), an operation manner is deduced from a theory multiple imputation by chained equations (MICE) and is implemented, to obtain the account number operation model that may meet an operation on the resource and the account number, thereby ensuring the expansibility of the accounting system.

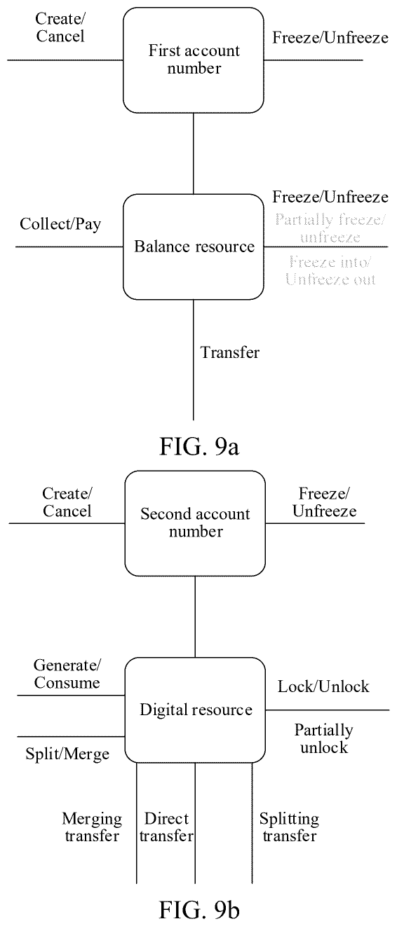

FIG. 9a is a schematic diagram of an operation model of a first account number according to an embodiment of the present disclosure. As shown in FIG. 9a, by using the operation model of the first account number, the first account number may be created/canceled, or may be frozen or unfrozen. The first account number may correspond to a balance resource, and operations such as collection, payment, a transfer, freezing, and unfreezing may be performed on the balance resource of the first account number by using the first account number. Similarly, FIG. 9b is a schematic diagram of an operation model of a second account number according to an embodiment of the present disclosure. As shown in FIG. 9b, by using the operation model of the second account number, the second account number may be created/canceled, or may be frozen or unfrozen. For a digital resource of the second account number, operations such as generation, consumption, splitting, merging, locking, unlocking, a merging transfer, a direct transfer, and a splitting transfer may be performed on the digital resource. Generating a digital resource is generating a digital resource with a unique identifier. Consuming a digital resource is using the digital resource in a transaction, where after the digital resource is used, the digital resource with the unique identifier becomes invalid. Freezing a digital resource or a balance resource is controlling a quantity of balance resources or digital resources, to prevent the digital resource or the balance resource from being used in another transaction. Unfreezing a digital resource or a balance resource is releasing quantity control on the balance resource or the digital resource and enabling the digital resource or the balance resource to be used in another transaction.

Integrated accounting can be implemented on a digital resource and a balance resource in a plurality of domain transaction scenarios by using the accounting system and the account number operation model provided in this embodiment of the present disclosure.

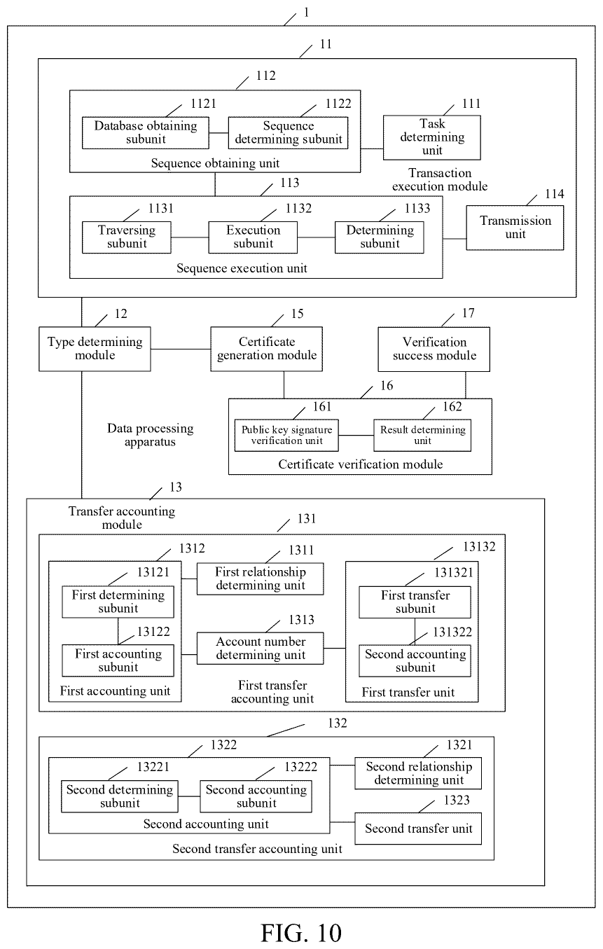

Refer to FIG. 10. FIG. 10 is a schematic structural diagram of a data processing apparatus according to an embodiment of the present disclosure. The data processing apparatus may be a computer program (including program code) running on an electronic device, and the electronic device includes at least one domain transaction component and a micro-core component. For example, the data processing apparatus may be application software. The data processing apparatus 1 may be configured to perform the corresponding operations in the data processing method provided in the embodiments of the present disclosure. As shown in FIG. 10, the data processing apparatus 1 may include a transaction execution module 11, a type determining module 12, and a transfer accounting module 13.

The transaction execution module 11 is configured to: receive, through a target domain transaction component among the at least one domain transaction component, a transaction task in a target field corresponding to the target domain transaction component, and execute the transaction task, to obtain a transaction execution result; and transmit the transaction execution result to the micro-core component through the target domain transaction component.

The type determining module 12 is configured to determine, through the micro-core component, a resource type associated with the transaction execution result.

The transfer accounting module 13 is configured to: determine, through the micro-core component based on the transaction execution result and the resource type associated with the transaction execution result, a transfer relationship between account numbers associated with the transaction task, and perform transfer accounting processing on resources of the account numbers based on the transfer relationship.

The resource type is a balance resource type; and
the transfer accounting module 13 includes: a first transfer accounting unit 131.

The first transfer accounting unit 131 is further configured to: determine, based on the transaction execution result, a balance transfer relationship between S first account numbers associated with the transaction task, and perform double-entry transfer accounting processing on balance resources of the S first account numbers based on the balance transfer relationship, where S is a positive integer.

The resource type is a digital resource type; and
the transfer accounting module 13 includes: a second transfer accounting unit 132.

The second transfer accounting unit 132, configured to: if the resource type is a digital resource type, determine, based on the transaction execution result, a digital resource transfer relationship between L second account numbers associated with the transaction task, and perform equivalent transfer accounting processing on digital resources of the L second account numbers based on the digital resource transfer relationship, where Lis a positive integer. Among the L second account numbers on which the equivalent accounting processing is performed, a total quantity of transferred-out digital resources corresponding to second account numbers of a transfer output type is equal to a total quantity of transferred-in digital resources corresponding to second account numbers of a transfer input type.

For implementations of the transaction execution module 11, the type determining module 12, and the transfer accounting module 13, refer to the descriptions of operations S101 to S104 in the embodiment corresponding to FIG. 3. Details are not described herein again.

The transaction execution result includes sequence transaction operation data.

The transaction execution module 11 includes: a task determining unit 111, a sequence obtaining unit 112, a sequence execution unit 113, and a transmission unit 114.

The task determining unit 111 is configured to: receive the transaction task through the target domain transaction component, and determine a task type of the transaction task through the target domain transaction component.

The sequence obtaining unit 112 is configured to obtain an accounting sequence matching the task type.

The sequence execution unit 113 is configured to execute the transaction task based on the accounting sequence, to obtain sequence transaction operation data corresponding to the transaction task.

The transmission unit 114 is configured to transmit the sequence transaction operation data to the micro-core component.

For implementations of the task determining unit 111, the sequence obtaining unit 112, the sequence execution unit 113, and the transmission unit 114, refer to the descriptions of operations S201 to S204 in the embodiment corresponding to FIG. 6. Details are not described herein again.

The sequence obtaining module 112 includes: a database obtaining subunit 1121 and a sequence determining subunit 1122.

The database obtaining subunit 1121 is configured to obtain an accounting sequence database associated with the target domain transaction component, the accounting sequence database including one or more configuration task types and an accounting sequence bound to each configuration task type.

The sequence determining subunit 1122 is configured to determine, as the accounting sequence matching the task type, an accounting sequence bound to a configuration task type that is the same as the task type in the accounting sequence database.

For implementations of the database obtaining subunit 1121 and the sequence determining subunit 1122, refer to the descriptions of operation S202 in the embodiment corresponding to FIG. 6. Details are not described herein again.

The accounting sequence includes M accounting operations, M being a positive integer.

The sequence execution unit 113 includes: a traversing subunit 1131, an execution subunit 1132, and a determining subunit 1133.

The traversing subunit 1131 is configured to traverse the M accounting operations, to obtain a k^{th} accounting operation, k being a positive integer less than or equal to K.

The execution subunit 1132 is configured to execute the transaction task based on the k^{th} accounting operation and k−1 pieces of transaction operation data, to obtain a k^{th} piece of transaction operation data.

The determining subunit 1133 is configured to: when traversing the M accounting operations is completed, determine k pieces of transaction operation data as the sequence transaction operation data.

For implementations of the traversing subunit 1131, the execution subunit 1132, and the determining subunit 1133, refer to the descriptions of operation S203 in the embodiment corresponding to FIG. 6. Details are not described herein again.

The data processing apparatus 1 further includes: a certificate generation module 15, a certificate verification module 16, and a verification success module 17.

The certificate generation module 15 is configured to: generate a transaction certificate for the transaction execution result through the target domain transaction component, and transmit the transaction certificate to the micro-core component.

The certificate verification module 16 is configured to perform verification processing on the transaction certificate through the micro-core component, to obtain a verification result.

The verification success module 17 is configured to: if the verification result is a verification success result, perform the operation of determining a resource type associated with the transaction execution result.

For implementations of the certificate generation module 15, the certificate verification module 16, and the verification success module 17, refer to the descriptions of operation S103 in the embodiment corresponding to FIG. 3. Details are not described herein again.

The transaction certificate includes signature data.

The certificate verification module 16 includes: a public key signature verification unit 161 and a result determining unit 162.

The public key signature verification unit 161 is configured to determine, through the micro-core component, a public key certificate associated with the target domain transaction component.

The public key signature verification unit 161 is further configured to perform signature verification processing on the signature data based on the public key certificate, to obtain a signature verification result.

The result determining unit 162 is configured to: if the signature verification result is a signature verification success result, determine that the verification result is a verification success result.

The result determining unit 162 is configured to: if the signature verification result is a signature verification failure result, determine that the verification result is a verification failure result.

For implementations of the public key signature verification unit 161 and the result determining unit 162, refer to the descriptions of operation S103 in the embodiment corresponding to FIG. 3. Details are not described herein again.

The micro-core component includes a transaction accounting layer and an object resource layer.

The first transfer accounting unit 131 includes: a first relationship determining unit 1311, a first accounting unit 1312, an account number determining unit 1313, and a first transfer unit 1314.

The first relationship determining unit 1311 is configured to determine, in the transaction accounting layer based on the transaction execution result, the balance transfer relationship between the S first account numbers associated with the transaction task.

The first accounting unit 1312 is configured to perform the double-entry accounting processing on the S first account numbers based on the balance transfer relationship, to obtain a double-entry accounting result.

The account number determining unit 1313 is configured to: if the double-entry accounting result is a double-entry accounting success result, determine, in the object resource layer, balance resource management account numbers respectively corresponding to the S first account numbers. One balance resource management account number is used for managing balance resources of one or more first account numbers.

The first transfer unit 1314 is configured to transfer the balance resources of the S first account numbers based on the balance transfer relationship and the balance resource management account numbers respectively corresponding to the S first account numbers.

For implementations of the first relationship determining unit 1311, the first accounting unit 1312, the account number determining unit 1313, and the first transfer unit 1314, refer to the descriptions of operation S104 in the embodiment corresponding to FIG. 3. Details are not described herein again.

The first accounting unit 1312 includes: a first determining subunit 13121 and a first accounting subunit 13122.

The first determining subunit 13121 is configured to: based on the balance transfer relationship, determine first account numbers that are among the S first account numbers and that are of a debit type as first debit account numbers, and determining first account numbers that are among the S first account numbers and that are of a credit type as first credit account numbers.

The first determining subunit 13121 is further configured to determine, based on the balance transfer relationship, debit balances respectively corresponding to the first debit account numbers.

The first determining subunit 13121 is further configured to determine, based on the balance transfer relationship, credit balances respectively corresponding to the first credit account numbers.

The first accounting subunit 13122 is configured to: if a sum of the debit balances respectively corresponding to the first debit account numbers is equal to a sum of the credit balances respectively corresponding to the first credit account numbers, record the debit balances respectively corresponding to the first debit account numbers and the credit balances respectively corresponding to the first credit account numbers, and determine that the double-entry accounting result is a double-entry accounting success result.

For implementations of the first determining subunit 13121 and the first accounting subunit 13122, refer to the descriptions of operation S104 in the embodiment corresponding to FIG. 3. Details are not described herein again.

The first transfer unit 1314 includes: a first transfer subunit 13141 and a second transfer subunit 13142.

The first transfer subunit 13141 is configured to: if the balance resource management account numbers respectively corresponding to the S first account numbers are the same, perform value update processing on account number balances in the S first account numbers based on the balance transfer relationship. One account number balance is configured to represent a quantity of balance resources that can be exchanged by one first account number from a balance resource management account number.

The second transfer subunit 13142 is configured to: if the balance resource management account numbers respectively corresponding to the S first account numbers are different, transfer, based on the balance transfer relationship, balance resources of the balance resource management account numbers respectively corresponding to the S first account numbers, to obtain a balance resource transfer result.

The second transfer subunit 13142 is further configured to perform value update processing on account number balances in the S first account numbers based on the balance resource transfer result.

For implementations of the first transfer subunit 13141 and the second transfer subunit 13142, refer to the descriptions of operation S104 in the embodiment corresponding to FIG. 3. Details are not described herein again.

The micro-core component includes a transaction accounting layer and an object resource layer.

The second transfer accounting unit 132 includes: a second relationship determining unit 1321, a second accounting unit 1322, and a second transfer unit 1323.

The second relationship determining unit 1321 is configured to determine, in the transaction accounting layer based on the transaction execution result, the digital resource transfer relationship between the L second account numbers associated with the transaction task.

The second accounting unit 1322 is configured to perform equivalent accounting processing on the digital resources of the L second account numbers based on the digital resource transfer relationship, to obtain an equivalent accounting result.

The second transfer unit 1323 is configured to: if the equivalent accounting result is an equivalent accounting success result, perform, in the object resource layer, digital resource transfer processing on the digital resources of the L second account numbers based on the digital resource transfer relationship.

For implementations of the second relationship determining unit 1321, the second accounting unit 1322, and the second transfer unit 1323, refer to the descriptions of operation S104 in the embodiment corresponding to FIG. 3. Details are not described herein again.

The second accounting unit 1322 includes: a second determining subunit 13221 and a second accounting subunit 13222.

The second determining subunit 13221 is configured to: based on the digital resource transfer relationship, determine second account numbers that are among the L second account numbers and that are of a transfer output type as second transfer-out account numbers, and determine second account numbers that are among the L second account numbers and that are of a transfer input type as second transfer-in account numbers.

The second determining subunit 13221 is further configured to determine, based on the digital resource transfer relationship, quantities that are of transferred-out unit digital resources and that are respectively corresponding to the second transfer-out account numbers.

The second determining subunit 13221 is further configured to determine, based on the digital resource transfer relationship, quantities that are of transferred-in unit digital resources and that are respectively corresponding to the second transfer-in account numbers.

The second accounting subunit 13222 is configured to: if a sum of the quantities that are of transferred-out unit digital resources and that are respectively corresponding to the second transfer-out account numbers is equal to a sum of the quantities that are of transferred-in unit digital resources and that are respectively corresponding to the second transfer-in account numbers, record the quantities that are of transferred-out unit digital resources and that are respectively corresponding to the second transfer-out account numbers and the quantities that are of transferred-in unit digital resources and that are respectively corresponding to the second transfer-in account numbers, and determine that the equivalent accounting result is an equivalent accounting success result.

For implementations of the second determining subunit 13221 and the second accounting subunit 13222, refer to the descriptions of operation S104 in the embodiment corresponding to FIG. 3. Details are not described herein again.

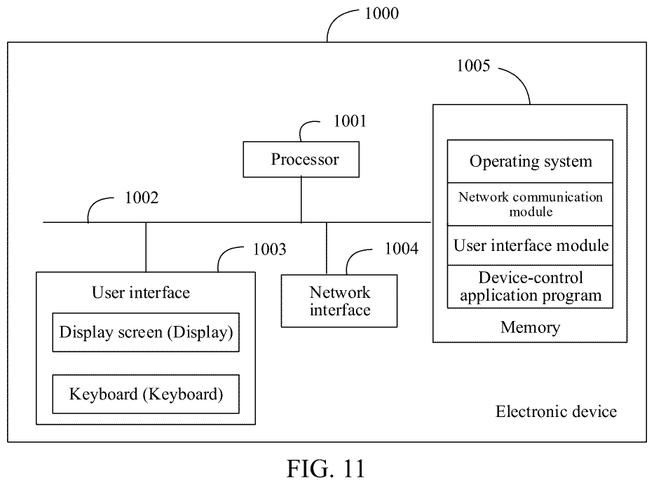

Refer to FIG. 11. FIG. 11 is a schematic structural diagram of an electronic device according to an embodiment of the present disclosure. As shown in FIG. 11, the data processing apparatus 1 in the embodiment corresponding to FIG. 10 may be configured as an electronic device 1000, and the electronic device 1000 may include: a processor 1001, a network interface 1004, and a memory 1005. In addition, the foregoing electronic device 1000 may further include: a user interface 1003 and at least one communication bus 1002. The communication bus 1002 is configured to implement connection and communication between the components. The user interface 1003 may include a display and a keyboard. The user interface 1003 may further include a standard wired interface and a standard wireless interface. The network interface 1004 may include a standard wired interface and a standard wireless interface (for example, a Wi-Fi interface). The memory 1005 may be a high-speed RAM memory, or may be a non-volatile memory, for example, at least one magnetic disk memory. In some embodiments, the memory 1005 may alternatively be at least one storage apparatus located far away from the processor 1001. As shown in FIG. 11, the memory 1005 used as a computer- readable storage medium may include an operating system, a network communication module, a user interface module, and a device-control application program.

In the electronic device 1000 shown in FIG. 11, the network interface 1004 may provide a network communication network element. The user interface 1003 is mainly configured to provide an input interface for a user. The processor 1001 may be configured to invoke the device-control application program stored in the memory 1005 to implement:
receiving, through a target domain transaction component among at least one domain transaction component, a transaction task in a target field corresponding to the target domain transaction component, and executing the transaction task, to obtain a transaction execution result;
transmitting the transaction execution result to a micro-core component through the target domain transaction component;
determining, through the micro-core component, a resource type associated with the transaction execution result; and
determining, through the micro-core component based on the transaction execution result and the resource type associated with the transaction execution result, a transfer relationship between account numbers associated with the transaction task, and performing transfer accounting processing on resources of the account numbers based on the transfer relationship.

The electronic device 1000 described in the embodiments of the present disclosure can implement the descriptions of the data processing method in the embodiment corresponding to FIG. 3 and/or FIG. 6. Details are not repeated herein. In addition, descriptions of beneficial effects of the same method are not described herein again.

In addition, an embodiment of the present disclosure further provides a computer readable storage medium. The computer readable storage medium stores a computer program executed by the data processing apparatus 1 mentioned above, and the computer program includes program instructions. When executing the program instructions, the processor can execute the foregoing descriptions of the data processing method in the embodiment corresponding to FIG. 3 and/or FIG. 6. Therefore, details are not described herein again. In addition, descriptions of beneficial effects of the same method are not described herein again. For technical details that are not disclosed in the embodiments of the computer-readable storage medium included in the present disclosure, refer to the descriptions of the method embodiments of the present disclosure.

The computer-readable storage medium may be a data processing apparatus provided in any one of the foregoing embodiments or an internal storage unit of the electronic device, such as a hard disk or a memory of the electronic device. The computer-readable storage medium may alternatively be an external storage device of the electronic device, for example, a removable hard disk, a smart media card (SMC), a secure digital (SD) card, or a flash card equipped on the electronic device. The computer-readable storage medium may further include both an internal storage unit and an external storage device of the electronic device. The computer-readable storage medium is configured to store a computer program and another program and data required by the electronic device. The computer-readable storage medium may alternatively be configured to temporarily store data that has been outputted or will be outputted.

In addition, an embodiment of the present disclosure further provides a computer program product or a computer program. The computer program product or the computer program includes computer instructions, and the computer instructions are stored in a computer-readable storage medium. A processor of an electronic device reads the computer instructions from the computer-readable storage medium, and executes the computer instructions, to cause the electronic device to perform the method in the embodiment corresponding to FIG. 3 and/or FIG. 6.

As disclosed, the transaction task may be received through the target domain transaction component included in the one or more domain transaction components, the transaction task is executed through the target domain transaction component, to obtain the transaction execution result, and the transaction execution result is transmitted to the micro-core component. Then, in the micro-core component, the resource type associated with the transaction execution result is determined. The transfer relationship between the account numbers associated with the transaction task is determined through the micro-core component based on the transaction execution result and the resource type associated with the transaction execution result, and the transfer accounting processing is performed on the resources of the account numbers based on the transfer relationship. Based on the method provided in the embodiments of the present disclosure, transaction tasks in different domain transaction scenarios are completed by corresponding domain transaction components, and a transfer accounting process is uniformly completed by the micro-core component. An execution process of a transaction task is decoupled from a transfer accounting process used in the transaction task, so that integrated accounting can be implemented on resources of different types in a plurality of domain transaction scenarios.

The terms “first”, “second”, and the like in the specification, the claims, and the accompanying drawings of the embodiments of the present disclosure are intended to distinguish between different objects, instead of describing a particular sequence. In addition, the terms “include”, “have”, and any variation thereof are intended to cover a non-exclusive inclusion. For example, processes, methods, apparatuses, products, or devices including a series of operations or modules are not limited to the listed operations or modules, but instead, include operations or modules not listed, or include other operations or units inherent to these processes, methods, apparatuses, products, or devices.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to network elements. Whether the functions are executed in a mode of hardware or software depends on particular applications and design constraint conditions of the technical solutions. A person skilled in the art may use different methods to implement the described network elements for each particular application, but it is not to be considered that the implementation goes beyond the scope of the present disclosure.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method, performed by an electronic device that comprises at least one domain transaction component and a micro-core component; and the method comprising:
receiving, through a target domain transaction component in the at least one domain transaction component, a transaction task in a target domain corresponding to the target domain transaction component, and executing the transaction task, to obtain a transaction execution result;
transmitting, through the target domain transaction component, the transaction execution result to the micro-core component;
determining, through the micro-core component, a resource type associated with the transaction execution result; and
determining, through the micro-core component based on the transaction execution result and the resource type associated with the transaction execution result, a transfer relationship between account numbers associated with the transaction task, and performing transfer accounting processing on resources of the account numbers based on the transfer relationship.

2. The method according to claim 1, wherein
the resource type is a balance resource type;
determining the transfer relationship between the account numbers associated with the transaction task comprises:
determining, based on the transaction execution result, a balance transfer relationship between S first account numbers associated with the transaction task; and
performing the transfer accounting processing on the resources of the account numbers based on the transfer relationship comprises:
performing double-entry transfer accounting processing on balance resources of the S first account numbers based on the balance transfer relationship, S being a positive integer.

3. The method according to claim 1, wherein
the resource type is a digital resource type;
determining the transfer relationship between the account numbers associated with the transaction task comprises:
determining, based on the transaction execution result, a digital resource transfer relationship between L second account numbers associated with the transaction task; and
performing the transfer accounting processing on the resources of the account numbers based on the transfer relationship comprises:
performing equivalent transfer accounting processing on digital resources of the L second account numbers based on the digital resource transfer relationship, L being a positive integer, and
among the L second account numbers after the equivalent transfer accounting processing, a total quantity of transferred-out digital resources corresponding to second account numbers belonging to a transfer output type is equal to a total quantity of transferred-in digital resources corresponding to second account numbers belonging to a transfer input type.

4. The method according to claim 1, wherein
the transaction execution result comprises sequence transaction operation data;
executing the transaction task, to obtain the transaction execution result comprises:
determining a task type of the transaction task through the target domain transaction component; obtaining an accounting sequence matching the task type; and executing the transaction task based on the accounting sequence, to obtain sequence transaction operation data corresponding to the transaction task; and
transmitting the transaction execution result to the micro-core component comprises:
transmitting the sequence transaction operation data to the micro-core component through the target domain transaction component.

5. The method according to claim 4, wherein
obtaining the accounting sequence matching the task type comprises:
obtaining an accounting sequence database associated with the target domain transaction component, the accounting sequence database comprising one or more configuration task types and an accounting sequence bound to each configuration task type; and
determining, as the accounting sequence matching the task type, an accounting sequence bound to a configuration task type that is the same as the task type in the accounting sequence database.

6. The method according to claim 4, wherein
the accounting sequence comprises M accounting operations, M being a positive integer; and
executing the transaction task based on the accounting sequence, to obtain the sequence transaction operation data corresponding to the transaction task comprises:
traversing the M accounting operations, and obtaining a k^{th} accounting operation, k being a positive integer less than or equal to M;
executing the transaction task based on the k^{th} accounting operation and k−1 pieces of transaction operation data, to obtain a k^{th} piece of transaction operation data; and
when traversing the M accounting operations is completed, determining k pieces of transaction operation data as the sequence transaction operation data.

7. The method according to claim 1, further comprising:
generating, through the target domain transaction component, a transaction certificate for the transaction execution result and transmitting the transaction certificate to the micro-core component;
verifying, through the micro-core component the transaction certificate, to obtain a verification result; and
in response to the verification result being a verification success result, performing the operation of determining the resource type associated with the transaction execution result.

8. The method according to claim 7, wherein
the transaction certificate comprises signature data; and
verifying the transaction certificate to obtain a verification result comprises:
determining, through the micro-core component, a public key certificate associated with the target domain transaction component;
performing signature verification processing on the signature data based on the public key certificate, to obtain a signature verification result; and
in response to the signature verification result being a signature verification success result, determining that the verification result is a verification success result; or in response to the signature verification result being a signature verification failure result, determining that the verification result is a verification failure result.

9. The method according to claim 2, wherein
the micro-core component comprises a transaction accounting layer and an object resource layer;
determining the balance transfer relationship between the S first account numbers associated with the transaction task comprises:
determining, in the transaction accounting layer based on the transaction execution result, the balance transfer relationship between the S first account numbers associated with the transaction task; and
performing the double-entry transfer accounting processing on the balance resources of the S first account numbers based on the balance transfer relationship comprises:
performing the double-entry accounting processing on the S first account numbers based on the balance transfer relationship, to obtain a double-entry accounting result;
in response to the double-entry accounting result being a double-entry accounting success result, determining, in the object resource layer, balance resource management account numbers respectively corresponding to the S first account numbers, one balance resource management account number being used for managing balance resources of one or more first account numbers; and
transferring the balance resources of the S first account numbers based on the balance transfer relationship and the balance resource management account numbers respectively corresponding to the S first account numbers.

10. The method according to claim 9, wherein performing the double-entry accounting processing on the S first account numbers comprises, based on the balance transfer relationship,
determining first account numbers that are among the S first account numbers and that are of a debit type as first debit account numbers, and determining first account numbers that are among the S first account numbers and that are of a credit type as first credit account numbers;
determining debit balances respectively corresponding to the first debit account numbers;
determining credit balances respectively corresponding to the first credit account numbers; and
in response to a sum of the debit balances respectively corresponding to the first debit account numbers being equal to a sum of the credit balances respectively corresponding to the first credit account numbers, recording the debit balances respectively corresponding to the first debit account numbers and the credit balances respectively corresponding to the first credit account numbers, and determining that the double-entry accounting result is a double-entry accounting success result.

11. The method according to claim 9, wherein transferring the balance resources of the S first account numbers based on the balance transfer relationship and the balance resource management account numbers respectively corresponding to the S first account numbers comprises:
in response to the balance resource management account numbers respectively corresponding to the S first account numbers being same, performing value update processing on account number balances in the S first account numbers based on the balance transfer relationship, one account number balance being configured to represent a quantity of balance resources that are able to be exchanged by one first account number from a balance resource management account number; or
in response to the balance resource management account numbers respectively corresponding to the S first account numbers being different, transferring, based on the balance transfer relationship, balance resources of the balance resource management account numbers respectively corresponding to the S first account numbers, to obtain a balance resource transfer result; and performing value update processing on account number balances in the S first account numbers based on the balance resource transfer result.

12. The method according to claim 3, wherein the micro-core component comprises a transaction accounting layer and an object resource layer;
determining the digital resource transfer relationship between L second account numbers associated with the transaction task comprises:
determining, in the transaction accounting layer based on the transaction execution result, the digital resource transfer relationship between the L second account numbers associated with the transaction task; and
performing the equivalent transfer accounting processing on the digital resources of the L second account numbers based on the digital resource transfer relationship comprises:
performing the equivalent accounting processing on the digital resources of the L second account numbers based on the digital resource transfer relationship, to obtain an equivalent accounting result; and
in response to the equivalent accounting result being an equivalent accounting success result, performing, in the object resource layer, digital resource transfer processing on the digital resources of the L second account numbers based on the digital resource transfer relationship.

13. The method according to claim 12, wherein performing the equivalent accounting processing on the digital resources of the L second account numbers based on the digital resource transfer relationship, to obtain the equivalent accounting result comprises: based on the digital resource transfer relationship,
determining second account numbers that are among the L second account numbers and that are of a transfer output type as second transfer-out account numbers, and determining second account numbers that are among the L second account numbers and that are of a transfer input type as second transfer-in account numbers;
determining quantities that are of transferred-out unit digital resources and that are respectively corresponding to the second transfer-out account numbers;
determining quantities that are of transferred-in unit digital resources and that are respectively corresponding to the second transfer-in account numbers; and
in response to a sum of the quantities that are of transferred-out unit digital resources and that are respectively corresponding to the second transfer-out account numbers being equal to a sum of the quantities that are of transferred-in unit digital resources and that are respectively corresponding to the second transfer-in account numbers, recording the quantities that are of transferred-out unit digital resources and that are respectively corresponding to the second transfer-out account numbers and the quantities that are of transferred-in unit digital resources and that are respectively corresponding to the second transfer-in account numbers, and determining that the equivalent accounting result is an equivalent accounting success result.

14. An electronic device, comprising one or more processors and a memory containing computer-executable instructions that, when being executed, cause the one or more processors to perform:
receiving, through a target domain transaction component in at least one domain transaction component of the electronic device, a transaction task in a target domain corresponding to the target domain transaction component, and executing the transaction task, to obtain a transaction execution result;
transmitting, through the target domain transaction component, the transaction execution result to a micro-core component of the electronic device;
determining, through the micro-core component, a resource type associated with the transaction execution result; and
determining, through the micro-core component based on the transaction execution result and the resource type associated with the transaction execution result, a transfer relationship between account numbers associated with the transaction task, and performing transfer accounting processing on resources of the account numbers based on the transfer relationship.

15. The device according to claim 14, wherein
the resource type is a balance resource type; and
the one or more processors are further configured to perform:
determining, based on the transaction execution result, a balance transfer relationship between S first account numbers associated with the transaction task; and
performing double-entry transfer accounting processing on balance resources of the S first account numbers based on the balance transfer relationship, S being a positive integer.

16. The device according to claim 14, wherein
the resource type is a digital resource type;
the one or more processors are further configured to perform:
determining, based on the transaction execution result, a digital resource transfer relationship between L second account numbers associated with the transaction task; and
performing equivalent transfer accounting processing on digital resources of the L second account numbers based on the digital resource transfer relationship, L being a positive integer, and
among the L second account numbers after the equivalent transfer accounting processing, a total quantity of transferred-out digital resources corresponding to second account numbers belonging to a transfer output type is equal to a total quantity of transferred-in digital resources corresponding to second account numbers belonging to a transfer input type.

17. The device according to claim 14, wherein
the transaction execution result comprises sequence transaction operation data; and
the one or more processors are further configured to perform:
determining a task type of the transaction task through the target domain transaction component; obtaining an accounting sequence matching the task type; and executing the transaction task based on the accounting sequence, to obtain sequence transaction operation data corresponding to the transaction task; and
transmitting the sequence transaction operation data to the micro-core component through the target domain transaction component.

18. The device according to claim 17, wherein
the one or more processors are further configured to perform:
obtaining an accounting sequence database associated with the target domain transaction component, the accounting sequence database comprising one or more configuration task types and an accounting sequence bound to each configuration task type; and
determining, as the accounting sequence matching the task type, an accounting sequence bound to a configuration task type that is the same as the task type in the accounting sequence database.

19. The device according to claim 17, wherein
the accounting sequence comprises M accounting operations, M being a positive integer; and
the one or more processors are further configured to perform:
traversing the M accounting operations, and obtaining a k^{th} accounting operation, k being a positive integer less than or equal to M;
executing the transaction task based on the k^{th} accounting operation and k−1 pieces of transaction operation data, to obtain a k^{th} piece of transaction operation data; and
when traversing the M accounting operations is completed, determining k pieces of transaction operation data as the sequence transaction operation data.

20. A non-transitory computer-readable storage medium containing computer-executable instructions that, when being executed, cause at least one processor of an electronic device to perform:
receiving, through a target domain transaction component in at least one domain transaction component of the electronic device, a transaction task in a target domain corresponding to the target domain transaction component, and executing the transaction task, to obtain a transaction execution result;
transmitting, through the target domain transaction component, the transaction execution result to a micro-core component of the electronic device;
determining, through the micro-core component, a resource type associated with the transaction execution result; and
determining, through the micro-core component based on the transaction execution result and the resource type associated with the transaction execution result, a transfer relationship between account numbers associated with the transaction task, and performing transfer accounting processing on resources of the account numbers based on the transfer relationship.
